(19) United States
(12) Patent Application Publication
(10) Pub. No.: US 2004/0065127 A1
(43) Pub. Date: Apr. 8, 2004

(54) Method of dewatering and preparing organic waste material for conversion into fertilizers

(76) Inventor: Larry V. Connell, Yakima, WA (US)

Correspondence Address: STRATTON BALLEW, 213 S 12TH AVE, YAKIMA, WA, 98902, US

(21) Appl. No.: 10/266,937

(22) Filed: Oct. 7, 2002

(51) Int. Cl. C05F 1/00

(52) U.S. Cl. 71/15

(57) ABSTRACT

An economical and effective process is provided to remove water from organic waste material, such as manure, and to further facilitate various different fertilizer applications or uses for the product material produced. The process employ a pulverizing air drier that utilizes a high impact vortex or cyclone of forced air. Additionally, the process sanitizes and the raw organic material and “micronizes” the organic material as well as or better than conventional thermal drying, which must be coupled with supplemental grinding or pulverizing techniques. To help preserve the nutritive, water soluble components of the raw organic material, the material is acidified prior to drying. To further minimize the loss of nutrients in the product fertilizer, water soluble components removed by the drying process can be recovered recycled back into the product. Additional nutritive component can be added to the material to produce a desired fertilizer formulation. The dried product also exhibits a substantial reduction in bacteria and pathogens, as compared to conventionally processed manure based fertilizers. Additionally, the product is substantially free of weed seeds and insects, all typically present in the raw organic manure material.

### TECHNICAL FIELD

The present invention relates generally to the use of various high moisture organic waste streams for the manufacture of organic-based fertilizers. Specifically, an economical solution is provided for sterilizing, dewatering and micronizing organic waste streams or biomass materials, such as manure, so they can be converted into a liquid fertilizer product, or alternatively a uniprill, granular fertilizer product.

### BACKGROUND OF THE INVENTION

The removal of water from organic matter has proven to be one of the greatest obstacles in economically manufacturing an organic material based fertilizer. Reducing the moisture, contained within these various water loaded materials, to a marketable level, has been a major processing challenge and economical barrier.

Organic waste material has proven to be a valuable resource in the manufacture of fertilizer products for farming and related agricultural operations. Organic waste material is generated from many varied sources. Farming is a chief source of organic waste, which can include dairy, hog, feedlot, chicken and crop residues. Some farm operations increase the quantities of organic waste generated by adding large amounts of water to organic waste effluent streams, as required to clean barns and pens. This creates large containment ponds and lagoons with an undesirably high “biological oxygen demand” (B.O.D.). A wet climate, or even an occasional storm event, can add considerably to the moisture generated in confined livestock operations, through rain and snow fall. A solution to this problem is needed that reduces and concentrates the large quantities of waste effluent from such operations, thereby reducing impacts upon the environment, especially to ground water and surface streams.

Two U.S. patents authored by the present inventor, U.S. Pat. No. 5,466,273 and U.S. Pat. No. 6,461,399 disclose processed for manufacturing organic fertilizers. U.S. Pat. No. 5,466,273 to Connell describes the conversion process of organic waste materials into a complete, balance, high grade fertilizer. In this prior disclosure by the present inventor, a 40% moisture level was found to be ideal for maximum nutrient retention and also allow efficient chemical reactions, yet was not too wet so as to interfere with product formation and increase drying costs. U.S. Pat. No. 6,461,399 to Connell discloses a sequential treatment process for an organic material fertilizer, prepared through a grinding process by mixing it with a calcium source followed by plant nutrients.

As these organic material based fertilizers fall under increased scrutiny for purity and safety, a process is needed that not only dries or de-waters the raw organic material, such as manure, but also sterilizes this organic material, to substantially neutralize or eliminate any bacteria, pathogens and weed seeds and insects within them.

A significant problem with organic waste generating facilities is the generation of odors. Odors are substantially tied to the generation of large quantities of high B.O.D. wastes associated with these facilities. Odors are a nuisance problem, typically encountered in the processing of manure and other organic waste materials. U.S. Pat. No. 3,966,460, describe a method of neutralizing odor in a chicken manure slurry. U.S. Pat. No. 3,966,450 describes a method of neutralizing odor in chicken waste slurry, employing hydrogen peroxide. However, a technique is needed to better convert the deodorized slurry produced by these prior art processes into a commercially viable fertilizer product. A solution is also needed that better addresses and minimizes these nuisance odors.

An economical solution is also needed to obtain a consistent moisture value in utilization of water saturated, wet organic materials in the creation of both a liquid and granular final product that efficiently deodorizes and sanitizes the raw, uncomposted organic waste.

### BRIEF DESCRIPTION OF DRAWINGS

FIG. 1 is a block flow schematic diagram of a method for manufacturing a raw product, organic-based fertilizer, according to an embodiment of the invention;

FIG. 2A is a block flow schematic diagram of a method for manufacturing an organic-based fertilizer from a raw product, according to an embodiment of the invention;

FIG. 2B is a block flow schematic diagram of a method for manufacturing an organic-based fertilizer from a raw product, according to an embodiment of the invention; and

FIG. 3 is a block flow schematic diagram of a method for producing a nutrient admixture in a manufacture of an organic-based fertilizer, according to an embodiment of the invention.

### DETAILED DESCRIPTION OF SPECIFIC EMBODIMENTS

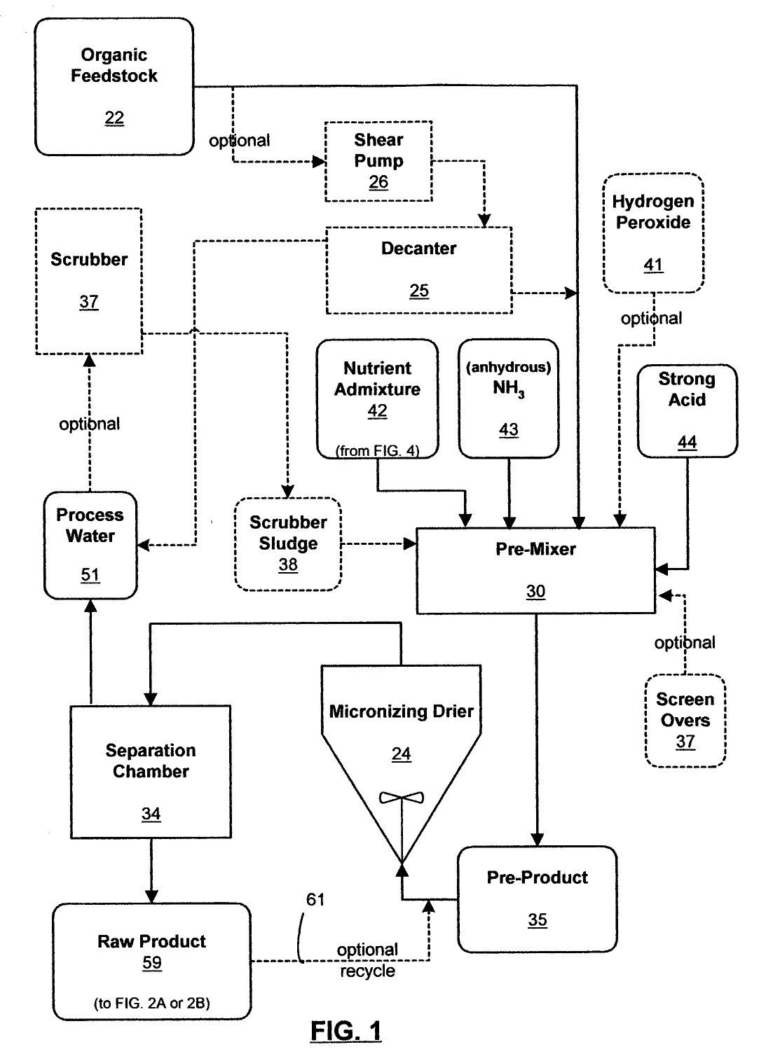

The process of the present invention provides an economical and effective way to remove water from organic waste material, such as manure, for the purpose of facilitating various different fertilizer applications or uses for the material produced. For example, some raw organic feedstocks may contain as much as 70% to 80% water, while others may only be in the 25% to 35% moisture level range. Economically reducing the moisture contained within these various water loaded materials, regardless of their initial moisture content, is a goal of the present invention. Additionally, to sanitize and the material, the process of the present invention sanitizes and “micronizes” the organic material, as well as or better than conventional thermal drying techniques, which must be coupled with supplemental grinding or pulverizing steps. The product of the present invention, as manufactured by the process shown in FIGS. 1 through 3, exhibits a substantial reduction in bacteria and pathogens, as compared to conventionally processed manure based fertilizers. Additionally, the product of the present invention is substantially free of weed seeds and insects, all typically present in raw organic materials.

Organic Feedstock

An organic feedstock 22, as shown schematically in FIG. 1, is selected on the basis of its nutrient content, moisture level, cost and availability. The organic feedstock preferably includes a substantial percentage of animal waste or manure materials. The organic feedstock can be broadly defined as any moist, organic material. A preferred organic material is a manure, such as chicken manure or cattle manure. Other raw solid organic wastes include dairy, hog, feedlot, and crop residue. Other organic materials well suited for the present invention, if properly pre-sterilized, include municipal sewage sludge, and animal processing wastes, such as a blood meal. Animal processing wastes are preferably pre-sterilized for use with the present invention. This can be achieved by conventional pasteurization methods.

The organic feedstock 22, can also, as preferred include biomass materials. Farming waste, crop residues, agricultural debris and lawn clippings can all be utilized and, preferably mixed with the manure materials or sewage sludges. The relative ratio of each component is based upon the desired end product formulation, as prescribed for a specific soil and crop need for the fertilizer application. This assessment of soil deficiencies versus crop nutrient needs can be made by any person skilled in the art of making such analyses. Typically, these persons are specialists in horticultural science, and often associated with university agricultural extension offices.

The present invention preferably utilizes a forced air, pulverizing drier to achieve an economical and efficient conversion of the organic material into a final product. The air dryer utilizes a high velocity air stream to dry and reduce the particle size of the infeed material to the micron size range. Therefore, as shown in FIG. 1 the drier can be referred to as a “micronizing” dryer 24. Remarkably, the micronizing dryer is a non-heated drying device, built substantially as shown and described in U.S. Pat. No. 6,425,933. A preferred dryer for use with the present invention is manufactured by Sirocco Dryers™, of Houston, Tex. The micronizing dryer is specially configured to receive a pre-product 35, which chiefly comprises the organic feedstock 22., as amended and mixed with certain fertilizer supplements, as described herein.

Decanter

Before introduction into the micronizing dryer 24, the water content of the organic feedstock 22, must be reduced to an initial processing level of approximately 50% to 65% water, by weight, and preferably to approximately 60% water, by weight. Only then can the material be processed through the dryer without plugging or fouling. The present invention optionally utilizes a decanter 25, as shown with dashed lines in FIG. 1, to initially process wet organic feedstocks to an acceptable moisture level. The decanter is a conventional, wet material processing device that is very effective and specifically preferred for use with the organic feedstock if it is overly or excessively saturated with water. The slurry of the organic feedstock enters the decanter to substantially separate the liquid components from the solid components of the slurry.

Broadly defined, the decanter 25 can be any conventional “weir” type of a decanting mechanism, or a gravity settling chamber or pool. The present invention can employ a conventional sieve or a picket type of decanter to increase the efficiency of the decanter. Alternatively for the decanter, the present invention can utilize a centrifugal press, or an auger press to dewater the organic feedstock to an upper limit, preferably near 60% water, which is acceptable for use in the micronizing dryer 24.

However, for waste stream dewatering, centrifugal devices are not conventionally employed with waste streams that lack homogeneity. For the decanting option of present invention, as shown in FIG. 1, the decanter 25 preferably includes a shear pump 26 to further pre-process the super saturated organic feedstock 22. The shear pump produces an ideal infeed material for the decanter. For the shear pump, a high shear, in-line mixing pump, as manufactured by Siverson Machines, Inc., of East Longmeadow, Mass., U.S.A., can be employed. The decanter is preferably a continuous flow decanter as well known in refined municipal sludge separation operations and most preferably a “C” series centrifugal decanter, as manufactured by CONTEC™, of San Leandro Calif., U.S.A.

For use with the present invention, a simple centrifugal type of decanter 25 has the demonstrated ability to process approximately 12 wet tons of material per hour, to a moisture level adequate for use in the micronizing dryer 24. Therefore, wet dairy and hog farm operations as well as chicken litter operations, regardless of the weather or the producers method of operation, can employ the process of the present invention.

From the decanter 25, the organic feedstock 22 solids are preferably transported by conveyor to a holding bin where they await processing into the first mixer 30. The liquid from the decanter are a process water 60, and after transport to a holding tank, can be further cleaned in a recovery device, such as a water borne particulate removal device. This conventional device can be a scrubber 37, as shown in FIG. 1. Alternatively, the process water can be directly recycled back to a farm operation, or blended into a final, liquid product 70, all utilizing the process of the present invention.

The process water can also be passed through a conventional pasteurizing process, for further sanitization.

Pre-Mixer

An up-front blending of a multiple of the organic feed stock 22, each having various moisture contents, which in-turn can be blended to an even and consistent moisture for processing through the micronizing dryer 24, are achieved with a pre-mixer 30. The pre-mixer is preferably a conventional agglomerator, or alternatively an auger type or screw type of mixer, as selected for solids that are dry to wetter materials, having a paste-like consistency.

The pre-mixer 30 can alternatively be a “pug mill,” which is, a conventional device employed for the mixing or “pugging” of heavy, typically viscous materials. Pug mills conventionally include one to several blades or paddles that vigorously mix the materials received within.

Also alternatively, the mixing step of the pre-mixer can also be achieved in a truck fitted with internal mixing capabilities, as found in many conventional “feed mixing” trucks.

As shown in a preferred embodiment of the present invention of FIG. 1, the pre-mixer 30 receives additives and amendments along with the organic feed stock 22. These additives and amendments can include hydrogen peroxide 41, a nutrient admixture 42, ammonia 43 and strong acid 44, combined together to form the pre-product 35, for introduction into the micronizing drier 20.

Addition of Nutrients

With the pre-product 35 in the pre-mixer 30, other specific materials are added to form a raw product 59. An important additive introduced into the pre-mixer is a “nutrient admixture” 42. The nutrient admixture can include many nutrient adjuncts 44, as shown in FIG. 4. These nutrient adjuncts preferably include a source of trace minerals 45, a nitrogen source 46, a sulfur source 47, a phosphorous source 48, a potash source 49, and a magnesium source 50.

These nutrient adjuncts can be tailored to yield a raw product 59 with a desired “analysis,” which is conventionally considered the “N-P-K” values, or weight-to-weight percentages of nitrogen, phosphate and potassium in a fertilizer.

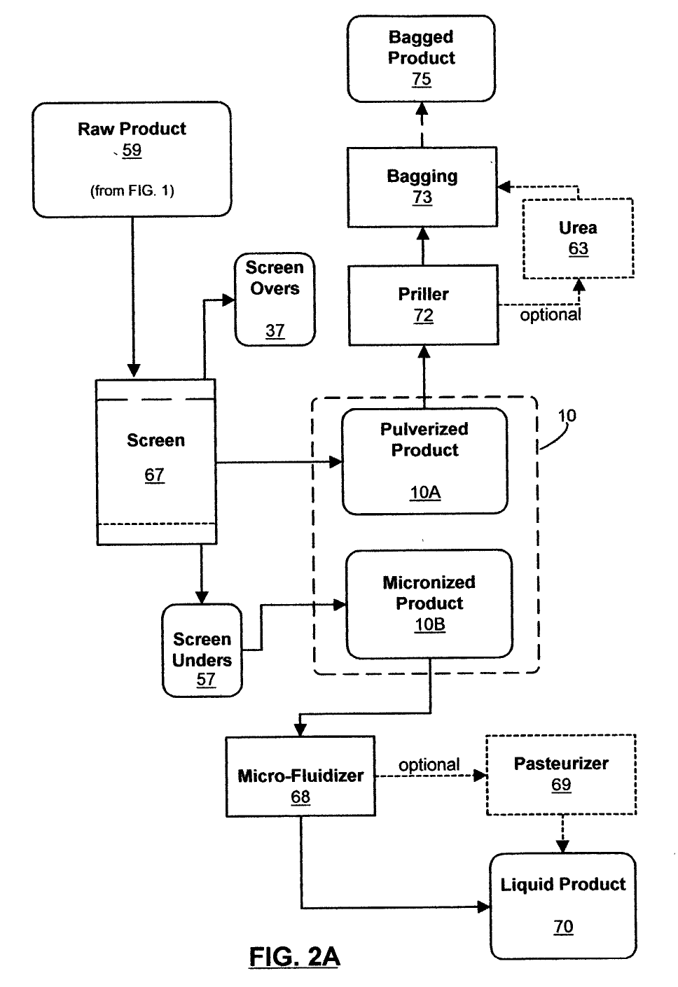

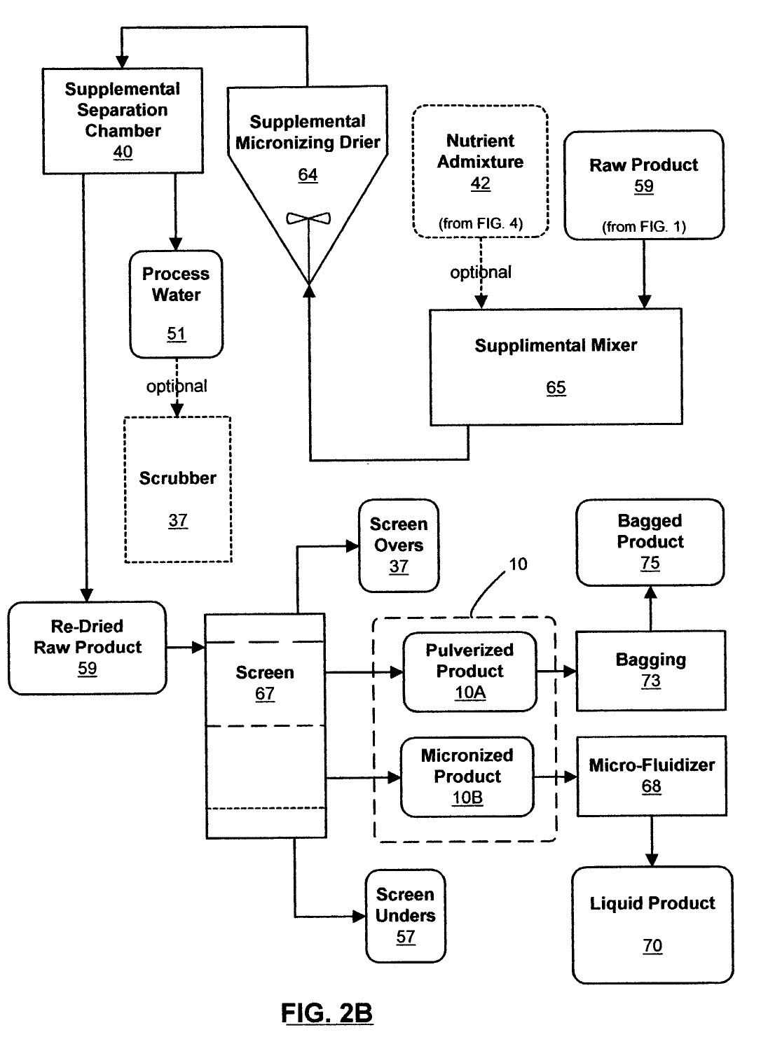

The formulation of the nutrient adjuncts 44 is also preferably established by first acquiring a soil chemical and biological analysis of the soils, at least generally, for the type of soil that will receive or be treated with the fertilizer product of the present invention. Additionally, the nutritional requirements of the crops planted or proposed for planting, which will receive the raw product 59, in either a pulverized product 10A form, or a micronized product 10B form, either easily converted into a liquid product 70, as detailed in FIG. 2B. With the initial assessment of the organic feedstock 22, and the ultimate fertilizer requirements, a list of needed nutrients can then be compiled. These nutrient requirements, as compared with a chemical analysis of the organic material, can dictate the chemical constituents of the nutrient adjuncts.

For the nutrient adjuncts 44, the nitrogen 46 source is preferably urea. However, this is considered a supplemental source, in addition to an anhydrous ammonia source (NH₃) 43, as noted in FIG. 1, for addition directly into the pre-mixer 30.

Additionally, for the nutrient adjuncts 44 of the present invention, the sulfur 47 source can be any elemental sulfur that is reasonably pure and free from unwanted impurities. The phosphorous 48 source is preferably a raw phosphorous ore. The potash 49 source is any appropriate potassium containing material, with the potassium typically in the form of potassium oxide (K₂O). A deodorizer 51 can also be included in the adjuncts. Preferably, the deodorizer can be a mint oil, an orange or other citrus essence, or any other conventionally utilized deodorizer. Beneficial bacterial cultures 52 can also be supplemented into the adjuncts, as needed or required. Depending upon the specifications or need of the final product, any of these adjuncts may be omitted as an option.

The nutrient adjuncts 44, are preferably pre-mixed in a nutrient mixer 55, to form the nutrient admixture 42. The nutrient admixture is added to the pre-product 35 in the pre-mixer 30, to satisfy the requirements of a balanced and complete plant food and soil adjuvant. Additionally, these adjunct nutrients can consist of but are not limited to: ammonium phosphate, nitrate, potassium sulfate, “sol-po-mag,” “K-Mag,” potassium chloride, rock phosphate, Chilean nitrate, trace minerals or soil adjuvants, as required. The selection of specific reactants and additives that contain the desired nutrient can additionally depend on whether a certified organic fertilizer or standard organic-based fertilizer is to be manufactured by the process of the present invention.

Before introduction into the pre-mixer 30, the nutrient adjuncts 44 are, as preferred, mixed in the nutrient mixer 55 with a quantity of a process water 51 and a binder 52, to form the nutrient admixture 42. The nutrient mixer is preferably circulated through a high speed, in-line mixer, which is most preferably a high shear, in-line mixer, as manufactured by Siverson Machines, Inc., of East Longmeadow, Mass., USA. The binder is preferably a wood processing waste product, such as lignin, lignite, lignin sulfonate, or alternatively a starch or sugary material, such as molasses, corn starch or potato starch.

The nutrient admixture 42 is preferably held in a tank or storage container until it is needed in the pre-mixer 30. Most preferably, the reagents in this container are circulated and blended to maintain the nutrient adjuncts in solution. As an alternative, the adjuncts can be mixed and stored in solid formulations, rather than liquid, and as an additional alternative, can be added individually, without first mixing, adding the process water 51 or adding the binder 52. However, to maintain a repeatable and consistent composition in the product, the combined addition of the adjuncts in the nutrient admixture is most preferred.

Lime Admixture

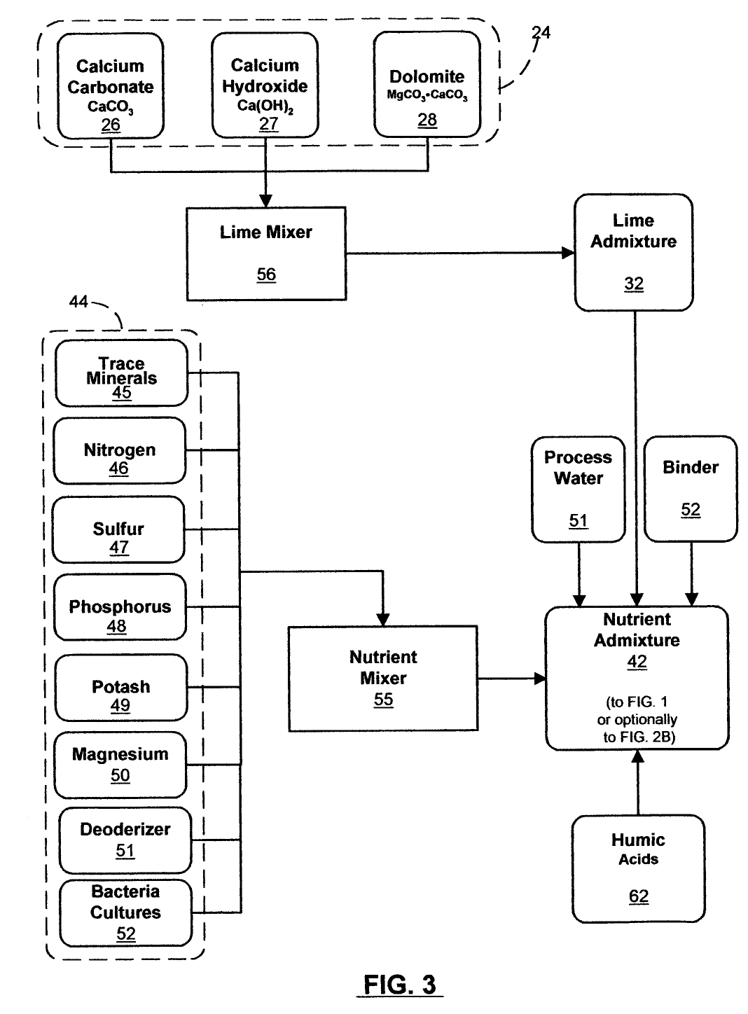

Preferably, a lime admixture 32 is included within nutrient admixture 42, as detailed in FIG. 3. The the lime admixture is combined with the organic feed stock 22 in a pre-grind processing step performed within a lime mixer 56. The lime mixer is preferably a vertical cyclone. Vertical cyclones are generally large grinding devices, especially suited to larger scale operations. Vertical cyclones have the unique ability to dry or drive off moisture as a material is ground, mixed and blended within. Most preferably, a conventional screw auger type of mixer is employed to grind and blend the lime admixture, together with the organic feedstock. The resultant product of the lime mixing is the lime admixture.

The lime admixture 32 is an important and fundamental component of the pulverized/micronized product 10 of the present invention. The lime admixture is a specific blend of a calcium salt material 24. The calcium salt materials are preferably either carbonated or hydrated salts of calcium. Most preferably, calcium carbonate (CaCO₃) 26, calcium hydroxide (Ca(OH)₂) 27, or mineral dolomite (MgCO₃.CaCO₃) 28, are the calcium salt materials employed, either alone or in combination.

The lime admixture 32 provides a source of calcium ions for the pulverized/micronized product 10. Calcium carbonate 26, or limestone, is a widely available material that is typically mined and converted into lime (CaO) in a furnace. Calcium hydroxide 27, or slaked lime, is a common byproduct of lime treated with water or used as a desiccant. Dolomite 28 is a common mineral that includes limestone and additionally magnesium carbonate. Magnesium is an important plant nutrient, and so dolomite is a preferred supplement to the lime admixture, especially when an analysis of soil or crop needs indicate that this supplement is required.

Based on price, availability and, importantly, the desired final composition of the pulverized/micronized product 10, the calcium salt materials 24 are blended in the lime mixer 56 to form the first lime admixture 32. The lime mixer is preferably an agglomerator. Agglomerators are generally defined as the upgrading of the size of fine particles. Most preferably the first mixer is a pin agglomerator, such as manufactured by FEECO, International of Green Bay Wis., USA. The preferred pin agglomerator includes a multiple of rotating pins that impact the materials of the lime admixture to begin a formation of small pellets, or “uniprills.”

The lime admixture 32 is preferably a solid phase mixture that can be stored in any appropriate location, such as bins, silos, trenches, or piles on a slab. However, the lime admixture should be protected from the weather, as rain will dissolve many of its constituents and wind can disperse it when the lime admixture is in the powdered form.

Organic Nutrients

Additional nutrients can now be added to the pre-mixer 30, especially organic nutrients that do not promote or require chemical reactions for activation. Specifically, a humic acid 62, or material rich in humic acids, is preferably supplemented into the second mixer as such an additional nutrient, as shown in FIG. 1. Humic acids are delicate, complex organic molecules. Acid/base reactions within prior process steps, such as within the first mixer or especially within the second mixer, can alter or degrade the humic acids, breaking them up and reducing their effectiveness as a storage molecule of essential plant nutrients. Therefore, the humic acid materials are preferably added to the pre-only after any and all energetic reactions, to keep the humic acids intact and preserve their full value.

Pre-Mixing Process

As shown in FIG. 1, the organic feedstock 22 is placed into the pre-mixer 30, where it is blended with the nutrient admixture 42. The nutrient admixture preferably includes the lime admixture 23., as formed by the process shown in FIG. 3. The lime admixture has a basic pH value of approximately between 8 and 11, and acts as a basifying agent to stabilize the organic feedstock. This stabilization is achieved by substantially halting the growth of the microbe populations within the organic feedstock. The lime admixture begins a chemical reaction with the organic feedstock to initiate a hydrolysis of the carbon-containing organic materials within the feedstock. Through hydrolysis, the reaction of the basic lime with the acidic organic feedstock provides bonding sites. This acid/base reaction also generates heat, which with the rise in pH, aids in a disinfection of the organic feedstock.

The pre-mixer 30 can also receive oversized product, designated in FIG. 1, as screen overs 37. The screen overs are generated in later process steps, which are shown in FIGS. 2A and 2B.

Lowering the pH

The nutrient admixture 42 is as preferred, is then additionally combined with a strong acid 44 in the pre-mixer 30. This strong acid is most preferably a combination of sulfuric acid and phosphoric acid. Additional or alternative acids, as are conventionally employed for such a purpose, can also be employed. In one such alternative, if the strong acid is sulfuric acid, the strong acid is metered into the second mixture to provide the needed final sulfur content for the micronized/pulverized product 10. Similarly, as an alternative, a phosphoric acid can be utilized to supplement the phosphorus content of the final product. Other acids that can be employed include nitric acid, carbonic acid, and various organic acids such as citric and fulvic acid, depending on the pH and nutrient requirements of the product. The acidification preferably brings the pH of the pre-product 30 to approximately pH 7, with approximately pH 5 being a lower limit and pH of 8, an upper limit.

Most preferably, an anhydrous ammonia (NH₃) 43 is first added to the organic feedstock 22, either followed by or in addition to the delivery of the nutrient admixture 42 to the pre-mixer 30. Strong acids 44 are then introduced into the pre-mixer. In a less preferred alternative, ether or both the anhydrous ammonia, or the nutrient admixture can be added after the strong acid. These nutrient and acid components, in predetermined quantities, are mixed in the first mixer to create a raw fertilizer pre-product 35 that includes the desired quantities of all sixteen commonly known mineral plant nutrients.

A primary purpose of the strong acid 44 is to beneficially treat the pre-product 35 by a standard acid/base reaction. An immediate and strong exothermic reaction occurs with temperatures reaching as high as approximately two hundred degrees F. The pre-product is substantially sanitized by the reaction, and additionally neutralized to liberate the carbonate ions as carbon dioxide gas.

The pre-mixer 30 preferably includes weighing vessel with its mixer capabilities. When the liquid nutrient admixture 42, having been premixed in a liquid mixing tank, is pumped into the first mixer, the weighing feature of the mixing vessel provides for an exact measurement of the additions to the first mixer. Such combination of mixing vessels with integral weighing capabilities are available from several manufacturers and are well known in the field of industrial chemical processing.

For a preferred embodiment of the present invention, the pre-mixer 30 is also employed to amend the organic feed stock. Most preferably, adequate quantities of a strong acid 44, and optionally a hydrogen peroxide 41, are added into the pre-mixer to create a deodorized, pre-product 35 of a homogeneous consistency, which is in contrast to the original condition of the raw organic solid waste that exhibited inconsistent moisture levels and typically an offensive odor.

Pre-Product

The organic feedstock 22, supplemented and chemically processed as discussed above, is discharged from the pre-mixer 30 as the pre-product 35. This pre-product is preferably stored in a bulk storage, which can be any appropriate storage device, such as a silo, trench or pile. Additionally, this bulk storage preferably acts as a surge flow buffer to provide for a constant pre-product flow to subsequent process steps. The pre-product is preferably covered to keep it from being leached by rainfall and to protect it from freezing.

Alternatively, the pre-product can be immediately transferred to the remaining steps of the process of the present invention. A significant benefit is achieved by the pre-treatment of the organic feedstock 22, as discussed above. The micronizing drier 24 is not a thermal device, the mechanism of the drier, as discussed below, relies upon aerosol formation of the water contained within the feedstock. This aerosolized water can then be driven off to produce a dramatic drying effect upon the feedstock. However, as found by the present inventor, a significant portion of the water soluble components of the organic feedstock and supplemental nutrient stream are also driven off with this water component, unless steps are taken to “lock-in” these nutrients in less soluble forms, prior to the vigorous, high-impact drying steps of the present process. The acidification of the organic feedstock provides this locking in and preservation of much of these water soluble nutrients, converting them from ions, into salts. Additionally, the preferred option of recovering and recycling the nutritive components of the process water 51, inadvertently removed from the drying process, as discussed later herein, also aids in the preservation of these important nutrients.

Micronizing Dryer

The preferred drying device, as embodied in the micronizing dryer 24 shown in FIG. 1, can be utilized during or after applying the method of U.S. Pat. Nos. 5,466,273 and 6,461,339, by the present inventor. In addition to drying the feedstock efficiently, particle size reduction is an added benefit in using the preferred dryer. Preferably, the micronizing and drying process operates by conveying the pre-product 35 via an auger into a high-speed air stream with a design velocity of up to 50,000 ft/min, under 6 psi. These high speed particles are then injected into a communition chamber that require the particles to circulate through a series of bars as well as increase in speed as they spiral downward toward an apex.

The Sirocco™ dryer, as discussed above and employed in a preferred embodiment of the present invention, a preferred configuration of the dryer includes a cone shaped communition chamber has a vertical shaft running down the center of the communition chamber. The vertical shaft includes a top bearing and a bottom bearing, at each end of the shaft. Attached to the vertical shaft are a multiple of 45-degree propeller blades of varying lengths to accommodate the cone shape of the communition chamber, which forces air into the apex at the bottom of the communition chamber. At the top of the communition chamber an intake opening introduces of a mixture of high-speed air and organic matter, preferably near a velocity of 50,000 feet per minute and at approximately 6 psig. The intake opening is mounted at an off-center angle into the cone such that it creates a “tornado effect” or vortex of circular swirling air, inside the cone. Preferably, impact bars or “elevations” are mounted on the inside walls of the communition chamber. The elevations are positioned in a configuration to be a destructive barrier to the organic particles in the air stream, as the air stream circulates within the communition chamber and proceeds towards the apex at ever increasing speeds.

In a preferred configuration of the Sirocco™ Dryer, the material passes through the bottom of the cone or the “apex.” The material is then channeled back and up the center of the cone, through the vortex or “the eye of the tornado,” via an exit pipe, and then out the top where it enters a separation chamber. This invention will have a gate opening perpendicular to the apex of the cone where an adjustable opening is present for escape of the organic matter and air stream into a separation chamber 34. The shaft and propellers occupy the center space and are spinning to create a downward push against the decreasing diameter of the cone. This pressure will increase the speed of the air stream to reach super sonic levels. Paddles at the apex are configured at right angles to the shaft to direct the air stream out of, rather than down the cone. The exit gate at the apex can be adjusted open or closed so as to achieve optimum air pressure and speed inside the chamber. Alternately, the air and pre-product 35 mixture feed rate can be adjusted by increasing or decreasing inlet flow entering the top of the chamber. All adjustments can be operated with the equipment running allowing for precise control over exacting amounts of particle reduction and moisture removal desired. This flexibility accommodates varying input materials and supports production of a range of diverse products required in the market place.

The desired result of reducing particle size by the micronizing drier 24 is accomplished through this forced, high-speed collision process. The reaction chamber has no moving parts and much of the sharing is achieved through velocity driven shearing action, rather than impacts with the wall of the chamber. Moisture content is separated by “micro-aerosolization” in which the water contained within the organic material is forced into the high velocity air stream. After the organic material or biomass solids are pulverized, a subsequent “separation chamber” 34 process, which gravimetrically separates the extracted water stream form the solids. This simple, yet very effective device has the added advantage of being much less expensive compared to purchase and operate than a thermal dryer, as shown in the following example:

### EXAMPLE 1

A cost comparison of the Sirocco™ dryer, used as the micronizing dryer 24, with a conventional, electric powered thermal dryer was preformed, using an organic feed material having a moisture content of approximately 70% by weight. The organic feed material and reducing the moisture content to approximately 10% by weight, the operational energy costs were reduced by 85%, which correlates to over a six fold decrease in energy costs, as significant savings in a major cost of producing the fertilizer product of the present invention.

Separation Chamber

The separation chamber 34, where the water aerosol is separated from a raw product 59, benefits from having barriers on the inside wall of the chamber to provide a surface for the particles to be obstructed and directed downward. The water vapor, noted in FIG. 1 as the process water 51, is forced out the top of the cone into a scrubber 37, if necessary. The materials removed by the scrubber can be referred to as a scrubber sludge 38, which can be recycled into the pre-mixer 30. As discussed above, this preferred recycling of the scrubber sludge recovers important water soluble and fine particulate nutrients driven off in the drying process.

Raw Product

The pulverized product 10A, especially after being treated by the priller 72, is a uniprill fertilizer. The term “uniprill” is again used to describe the formulation of a preferred product of the present invention. The uniprill formulation is defined as a finely granulated product, wherein each granule substantially contains the same ingredients, in the same proportions, as the product in bulk. The pulverized/micronized product 10 contains all the sixteen elements, recognized as necessary for optimum plant health.

To additionally supplement the nitrogen content of the pulverized product 10A, a spray of urea 63 can be added to the product after the priller, as shown in FIG. 2A. In addition to increasing the ready availability of nitrogen, the urea acts as a coating agent on the exterior of the prilled product, to improve handling and prevent cohesion between the granular uniprilled particles.

Screening

Preferably, as shown in FIGS. 2A and 2B, the classification of the raw product 59 is accomplished in a screen 67. As preferred, the screen can include a two deck sizing, as shown in FIG. 2A or alternatively a three deck sizing, as shown in FIG. 2B. The screen's decks classify the raw product into size fractions. With the two deck screen of FIG. 2A, the screens overs 37 are prevented from passing through the top, coarsely meshed screen, while the screen unders pass completely through the screen, including the bottom, finely meshed screen. Also, as with the two deck screen, the screen overs are preferably recycled back into the process, most preferably into the pre-mixer 30, and the screen unders 57 form the micronized product 10B.

As shown in FIGS. 2A and 2B, the screen 67 produces a pulverized product 10A, along with the micronized product 10B. The pulverized product is a coarser product, as compared to the micronized product. Within the screen, the pulverized product does not pass through an intermediate mesh that has a mesh size between the coarsely meshed screen and the finely meshed screen. The micronized product is the size fraction of the raw product 59 that passes through the intermediate mesh of the screen. In the three deck alternative, as shown in FIG. 2B, the micronized product does not pass through the fine mesh at the bottom of the screen. Preferably, the finely meshed screen has a mesh size of approximately 18 standard mesh.

The resulting uniprill product 10, especially the second uniprill product 10B, as preferably produced by the process as shown in FIG. 3, can be processed with a micro-fluidizer 68. Preferably, the micro-fluidizer is a high shear, micronizing line mixer, again as preferably manufactured by Siverson Machines, Inc., of East Longmeadow, Mass., U.S.A. The rotors and stators in the workheads of this conventional device homogenizes, dissolves, disperses, disintegrates and emulsifies down to a ten micron to 60 micron range, with the ability easily pass through a 200 mesh screen. This microscopic size range satisfies drip irrigation and special suspension application requirements.

The coarse uniprill product, specifically the pulverized product 10A, as produced by the process of the present invention, and shown in FIG. 2A, includes particles ranging from approximately 8 to 12 standard mesh screen size, which meets many farm and garden requirements.

Optional Supplemental Drying

In an alternative embodiment of the present invention, as shown schematically in FIG. 2B, the raw product can be re-dried in a supplemental micronizing drier 64. The supplemental micronizing drier may be an additional drier, as preferably embodied in a Sirocco™ drier. Alternatively, the drier for this supplemental drying step can be the micronizing drier 24, as preferably accomplished by a second pass through the drier. This optional recycle 55 is shown in FIG. 1.

A supplemental separation chamber 40, where water aerosol and vapor noted in FIG. 2B as the process water 51, is forced out the top of the cone of the supplemental micronizing drier 64, and processed by the optional scrubber 37, if necessary. As shown in FIG. 1, the materials removed by the scrubber can be referred to as a scrubber sludge 38, which can also be recycled into the pre-mixer 30, if desired.

As shown in FIG. 2B, the raw product 59 fed into the supplemental drier 64 further micronizes and dries the raw product into a “uniprill,” or uniform and homogenous particle. The moisture content of the raw product material is thereby reduced to a desired level, which is approximately 15% to 20% moisture, by weight. The supplemental drier can alternatively be a conventional rotary or drum drier, having a natural gas fired burner for driving off moisture from the raw product material.

Also alternatively, if after a first pass through the micronizing drier 24, the raw product 59 still contains too much moisture, the optional recycle 61 stream of the raw product can be back fed into the drier. This recycle stream can be any fraction of the dried raw product stream, as required to achieve the desired final moisture content.

Optional Nutrient Addition

The preferred processing of the organic feedstock 22, shown in FIG. 1, includes the addition of various additives into the pre-mixer 30, such as the nutrient admixture 42. In an alternative to or addition to the feeding of the nutrient admixture into the pre-mixer, the nutrient admixture can be optionally added to a supplemental mixer 65, as shown in FIG. 2B. This alternative embodiment can provide for better control of the nutrient and conventional N-P-K analysis of the final, micronized/pulverized product 10.

Micronized and Pulverized Product

After the drying pulverizing step of the micronizing drier 24, the raw product 59 is sized fractionated in the screen 67, as shown in FIGS. 2A and 2B. The granular fraction forms the pulverized product 10A. As discussed above, the screen 67 can be a conventional two deck screen, as shown in FIG. 2A. The coarsely meshed top deck prevents larger screen overs 37 from passing through. The size fraction that remains between the coarsely meshed screen an the finely meshed scree can be run through a priller 72 and then packaged for sale. The priller is preferably a conventional “disc granulator,” as often used in the industry to granulate finely pulverized materials. The uniprill product is sized preferably between 30 and 400 standard mesh size, which can be packaged and distributed for sale, or sold in bulk. Preferably, as shown in FIG. 2A, this packaging can include bagging 73 to produce a bagged product 75.

The screen unders 57, that pass though the fine mesh deck of the screen to form the micronized product 10B, can fed into a micro-fluidizer 68 to produce a liquid product 70 that is ideal for irrigation applications, such as with sprinklers or drip irrigation systems.

The following Example 2, shows how a typical batch of organic feedstock 22 can be processed by the method of the present invention:

### EXAMPLE 2

Approximately 100 pounds of a chicken manure biomass, with 72% moisture by weight, was processed as an organic feed stock 22 through a small scale version of a micronizing drier 24, manufactured Sirocco™ Dryers of Houston, Tex., and protected under U.S. Pat. No. 6,425,933. After passing through the separation chamber of the dryer device, the water content of the biomass was measured at 45% moisture, by weight.

This raw product 59 was then further processed with the required nutrient admixture 42, ammonia 43, and strong acid 44, to make an 8-5-5 N-P-K, organic based fertilizer, corresponding to a 8 percent nitrogen, 5 percent phosphorous and 5 percent potassium, by weight. This processing, substantially following the method of the present invention, reduced the moisture level to 35% water, by weight. Subsequently, the enriched raw product was again introduced into the above described dryer, employed as a supplemental micronizing drier 64.

The re-dried raw product 59 produced in this example was analyzed to contain 10% moisture by weight. Passing the re-dried raw product through the screen 67, gave the sizing classifications listed in Table 1, as follows:

TABLE 1

| Percent Recovered | Approx. Mesh Size | Percent Passed Through |
|---|---|---|
| 5% | over 25 | 95% under |
| 21% | over 50 | 74% under |
| 16% | over 100 | 59% under |
| 24% | over 200 | 34% under |
| 34% | under 200 | |
| 100% (total) | | |

As is typical for the present disclosure, in Table 1 above, the percentage results are reported as weight to weight percentages. Additionally, as typical throughout the present disclosure, the mesh sizes are reported as standard “Tyler” mesh equivalents and are variable within normal manufacturing standards in the industry.

Pasteurization of the Liquid Product As shown in FIG. 2A, after passing the micronized product 10B through the micro-fluidizer 68, the liquid stream can be further treated to produce a substantially sterile product. The liquid product 70 can pass through a pasteurizer 69. The pasteurizer employs heat to kill the pathogens present within the liquid stream. Other conventional sterilization methods are also considered to utilized in the process of the present invention, including irradiation of the liquid product, or alternatively the pulverized product 10A, with electromagnetic energy, such as micro-waves, or alternatively ultraviolet light.

Other Advantages of the Invention

The process of the present invention can handle a multiple varieties of the organic feedstock 22, with various moisture levels. Typically, over 50% water in a feedstock is considered wet and under 50% is considered dry. During the initial, wet phase of the feedstock, which is usually 70% water or more, the biomass can be more easily passed through the shear pump, as preferably included in the decanter 25, where as low as 20 micron particle size can be obtained. Yet from these various micronized waste steams, approximately a 40%, or lower, final moisture level can be constantly obtained from the micronizing dryer 24. A pre-product with a 50% moisture level, or higher may be utilized in the present invention with subsequent drying steps, or alternatively in fertilizer application not requiring dry product.

A biological examination of the bacterial present in the final, micronized and pulverized product 10, as referred to in FIGS. 2A and 2B as either the first pulverized product 10A, or the second pulverized product 10B, shows a significant sanitization. The final bacteria concentration is as compared to a sample of the organic feedstock 22 received by the plant employing the process of the present invention. Specifically, laboratory analysis of untreated chicken manure feed stock contains over 1 million CFU/g (Colony Forming Units per gram) of anaerobic bacteria. After treatment with the process of the present invention, the pulverized product contained approximately 12 thousand CFU/g of this bacteria, as analyzed substantially per standard “methods of soil analysis” (MoSA 37-5.2).

This reduction in bacteria is very significant and is considered a key inventive feature of the present invention. Specifically, the use of pulverizing air dryers to manufacture sanitized fertilizers was not considered prior to the present invention, in that these types of dryers failed to kill pathogens within the material, as disclosed in U.S. Pat. No. 6,425,933. In fact, this failure to reduce the bacteria counts in the drier was actually considered a benefit of the prior art use of the drier device.

With the process of the present invention, the micronizing air dryer can be employed in a process that manufactures a sanitized organic fertilizer product with a significantly decreased “biological oxygen demand” (B.O.D.), as compared to the raw, unprocessed organic feedstock, which can be any conventional farm operation effluent. Odors are also neutralized by the present process, by the use of additives and the arrest of biological activity in the feedstock.

The process of the present invention can accept a super-saturated biomass. Therefore, a plant employing the process can operate in all weather and for any method of farming. What ever the moisture content of the organic material delivered, it can be processed through the plant without adjusting down-line equipment. When employed with the process of the present invention, the decanter 25 can be adjusted, while running, to increase or decrease the amount of moisture in the solids and the amount of solids in the liquid. The process of the present invention also allows for the adjustment of all down-line processing equipment to work at peak performance. For example, the disc granulator, or priller 72, operates well at 25% to 30% moisture levels.

The process of the present invention also performs more efficiently than conventional water separation methods. For example, a screw press is slow and can only achieve moisture levels of approximately 65% water. This gain in efficiency greatly reduces drying costs by reducing the horsepower required to perform necessary dewatering and micronizing procedures.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A process for manufacturing an organic material based fertilizer that substantially retains a water soluble nutrient present within the organic material, the process including the steps of:
a) acidifying the organic material to form a pre-product material; and
b) dewatering and micronizing the pre-product material within a micronizing air dryer to form a fertilizer product, the micronizing drier employing a high velocity stream of forced air supplied into a vortex chamber that uses a cyclonic action to dry and pulverize the pre-product.

2. The process of claim 1, wherein the step of acidifying the organic material to form a pre-product material further includes the step of:
a2) substantially converting a water soluble component ion within the organic material into a substantially water insoluble salt of the ion.

3. The process of claim 1, wherein the step of acidifying the organic material to form a pre-product material further includes the step of:
a2) mixing an organic feedstock with a nutrient admixture and a nitrogen source.

4. The process of claim 1, further including the step of:
c) recovering an aerosolized water soluble nutrient removed in the drying process and recycling the aerosolized water soluble nutrient into the pre-product material.

5. The process of claim 1, wherein the step of dewatering and micronizing the pre-product material further includes the step of:
b2) drying the pre-product to a water content of less than 50 percent, by weight.

6. The process of claim 1, additionally including the step of:
c) fluidizing the fertilizer product to form a liquid product, the liquid product comprising a micronized, organic based fertilizer.

7. The process of claim 6, wherein the step of fluidizing the fertilizer product to form a liquid product further includes the step of:
d) micronizing the liquid fertilizer product to accommodate a liquid irrigation application of the liquid fertilizer, the liquid fertilizer product having a maximum particle size of approximately 10 to 60 microns.

8. The process of claim 6, additionally including the step of:
d) pasteurizing the liquid product, to form a sterilized liquid product.

9. The process of claim 1, additionally including the step of:
c) granulating the fertilizer product to form a uniprilled product, the uniprilled product comprising a micronized, organic based fertilizer.

10. A method of dewatering and micronizing an organic material for the purpose of manufacturing an organic based fertilizer, the method comprising the steps of:
a) mixing an organic feedstock with a nutrient admixture and a nitrogen source;
b) acidifying the organic feedstock to a pH of approximately between pH 5 and pH 7; and
c) drying and micronizing the mixed organic material in a forced air cyclonic drier pulverizer and impactor to form a pre-product, the cyclonic impactor including a downstream chamber for separating the water aerosols from a raw product.

11. The method of claim 10, wherein the drying and micronizing step additionally includes the step of drying:
c2) the raw product to a water content of less than approximately 50 weight percent.

12. The method of claim 10, additionally including the step of:
d) formulating the nutrient admixture to produce a pre-product having a specific fertilizer formulation, the specific fertilizer formulation compared with a chemical analysis of the organic feedstock to determine the needed formulation of the nutrient admixture.

13. The method of claim 10, further including the step of:
d) adding additional plant nutrients to the pre-product.

14. A process for manufacturing an organic material based fertilizer that substantially retains a water soluble nutrient present within the organic material, the process including the steps of:
a) acidifying the organic material to form a pre-product material; and
b) dewatering and micronizing the pre-product material within a micronizing air dryer to form a fertilizer product, the micronizing drier employing a high velocity stream of forced air supplied into a vortex chamber that uses a cyclonic action to dry and pulverize the pre-product, the pre-product having a water content of less than 50 percent, by weight.
